(19) United States
(12) Patent Application Publication
(10) Pub. No.: US 2015/0222871 A1
(43) Pub. Date: Aug. 6, 2015

(54) IMAGE PROCESSING METHOD, IMAGE PROCESSING DEVICE, AND ELECTRONIC DEVICE

(71) Applicant: Sony Corporation, Tokyo (JP)

(72) Inventors: Kentaro Doba, Tokyo (JP); Yasuhide Hyodo, Tokyo (JP)

(73) Assignee: Sony Corporation, Tokyo (JP)

(21) Appl. No.: 14/604,873

(22) Filed: Jan. 26, 2015

(30) Foreign Application Priority Data
Feb. 5, 2014 (JP) 2014-020400

(51) Int. Cl. H04N 13/00; H04N 13/04

(52) U.S. Cl. CPC H04N 13/0033; H04N 13/0402; H04N 13/0022; H04N 2013/0092; H04N 2213/002

(57) ABSTRACT

There is provided an image processing method including acquiring an original image and a parallax map indicating distribution of parallaxes in the original image, dividing the acquired original image into a plurality of regions based on objects in the original image, and adjusting at least a parallax of one region relative to another region different from the one region, among the regions, based on information associated with the one region or the another region, in a range where a dynamic range of the parallax in the parallax map is maintained.

### CROSS REFERENCE TO RELATED APPLICATIONS

This application claims the benefit of Japanese Priority Patent Application JP 2014-020400 filed Feb. 5, 2014, the entire contents of which are incorporated herein by reference.

### BACKGROUND

The present disclosure relates to an image processing method, an image processing device, and an electronic device.

There is developed a three-dimensional (3D) image technology allowing a viewer to feel an image stereoscopically by presenting him/her the image having different parallaxes for right and left eyes. As the method of presenting different images for right and left eyes, there is proposed, from the past, a system using dedicated glasses. Recently, there has been proposed a naked-eye 3D image technology capable of presenting a 3D image without any dedicated glasses.

### SUMMARY

However, it is known that long-time viewing of 3D images causes eye strain, and the strain tends to appear remarkably particularly when viewing images with large parallaxes. Moreover, in the naked-eye 3D image technology, when the parallax is large, there may be occurred a phenomenon called crosstalk in which an image corresponding to one eye of right and left eyes may be leaked to the other eye and appears as a defocused image or a double image.

On the other hand, JP 2006-115198A proposes a technology for suppressing the magnitude of a parallax. Such a technology for suppressing the magnitude of a parallax serves effectively as prevention of eye strain or suppression of crosstalk. However, the stereoscopic effect may be restricted with suppression of a parallax.

Then, the present disclosure proposes a new and improved image processing method, image processing device and electronic device that are capable of emphasizing the stereoscopic effect in the state where the magnitude of a parallax is restricted.

According to an embodiment of the present disclosure, there is provided an image processing method including acquiring an original image and a parallax map indicating distribution of parallaxes in the original image, dividing the acquired original image into a plurality of regions based on objects in the original image, and adjusting at least a parallax of one region relative to another region different from the one region, among the regions, based on information associated with the one region or the another region, in a range where a dynamic range of the parallax in the parallax map is maintained.

According to an embodiment of the present disclosure, there is provided an image processing device including an acquisition unit configured to acquire an original image and a parallax map indicating distribution of parallaxes in the original image, a region division unit configured to divide the acquired original image into a plurality of regions based on objects in the original image, and a parallax adjustment unit configured to adjust at least a parallax of one region relative to another region different from the one region, among the regions, based on information associated with the one region or the another region, in a range where a dynamic range of the parallax in the parallax map is maintained.

According to an embodiment of the present disclosure, there is provided an electronic device including an acquisition unit configured to acquire an original image and a parallax map indicating distribution of parallaxes in the original image, a region division unit configured to divide the acquired original image into a plurality of regions based on objects in the original image, and a parallax adjustment unit configured to adjust at least a parallax of one region relative to another region different from the one region, among the regions, based on information associated with the one region or the another region, in a range where a dynamic range of the parallax in the parallax map is maintained.

As is described above, according to the present disclosure, there are provided a new and improved image processing method, image processing device and electronic device that are capable of emphasizing the stereoscopic effect in the state where the magnitude of a parallax is restricted.

Note that the above-mentioned effect is not necessarily restrictive. In addition to or instead of the above-mentioned effect, there may be exerted any effect described in the specification or another effect that can be grasped based on the specification.

### BRIEF DESCRIPTION OF THE DRAWINGS

FIG. 1 is an explanatory diagram illustrating an example of a schematic configuration of a system including an image processing device according to an embodiment of the present disclosure;

FIG. 2 is an explanatory diagram illustrating an example of a schematic configuration of a display device according to the embodiment;

FIG. 3 is a block diagram illustrating an example of a functional configuration of the image processing device according to the embodiment;

FIG. 4 is a diagram illustrating an example of an original image.

FIG. 5 is a diagram illustrating an example of a parallax map;

FIG. 6 is a diagram for explaining region division of an original image;

FIG. 7 is an explanatory diagram for explaining processing of adjusting parallax values;

FIG. 8 is a diagram illustrating an example of a parallax map after adjustment;

FIG. 9 is a flowchart illustrating a sequence flow of processing of the image processing device according to the embodiment;

FIG. 10 is a block diagram illustrating an example of a functional configuration of an image processing device according to a modification;

FIG. 11 is a diagram illustrating an example of a hardware configuration;

FIG. 12 is a perspective view illustrating an external appearance of an application example 1 of the image processing device (a television device) according to the embodiment; and

FIG. 13 is a perspective view illustrating an external appearance of an application example 2 of the image processing device (a smartphone) according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be provided in the following order.

### 1. Configuration

### 1.1. Overview

1.2. Configuration of display device
1.3. Configuration of image processing device
2. Processing flow

### 3. Modification

4. Hardware configuration
5. Application examples

### 6. Conclusion

### 1. CONFIGURATION

### [1.1. Overview]

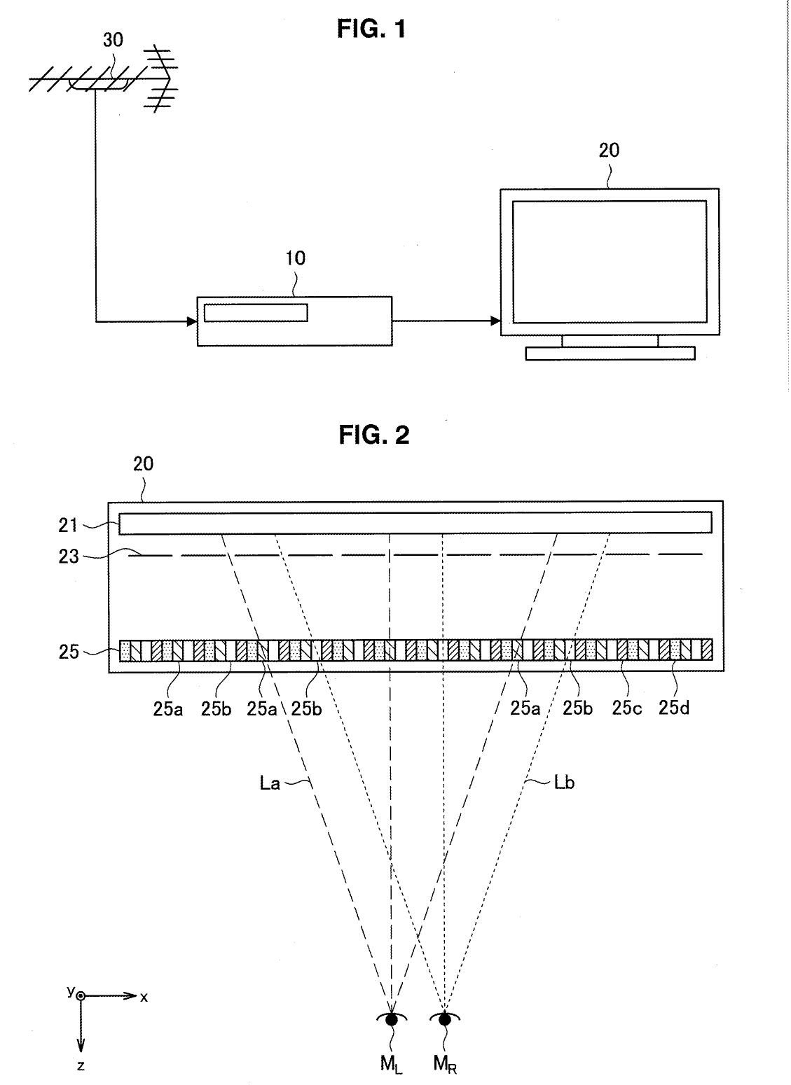

First, the overview of an image processing device according to the embodiment will be described with reference to FIG. 1. FIG. 1 is an explanatory diagram illustrating an example of a schematic configuration of a system including the image processing device according to the embodiment.

As illustrated in FIG. 1, an image processing device 10 of the embodiment is connected to a display device 20. Note that the image processing device 10 may be included in the display device 20. Hereinafter, the explanation will be given supposing that the image processing device 10 is provided as a separate housing from the display device 20.

In the display device 20 of the embodiment, a plurality of (at least two or more) virtual viewpoints are preliminarily set at given positions different from one another in front of a display surface of the display device 20, and a viewer can view viewpoint images different depending on the virtual viewpoints. In such a configuration, when a position of each virtual viewpoint is preliminarily adjusted so that each of right and left eyes of a viewer has a different virtual viewpoint, and a parallax image with a parallax different for each virtual viewpoint is displayed, for example, the viewer can view an image having a stereoscopic effect. A naked-eye 3D display is one concrete example of the display device 20. Hereinafter, the explanation will be given supposing that the display device 20 is configured as a naked-eye 3D display enabling stereoscopic vision.

The image processing device 10 externally acquires an original image to be displayed, generates a viewpoint image corresponding to each virtual viewpoint based on the acquired original image, and outputs the viewpoint image to the display device 20. For example, the image processing device 10 may be connected to an antenna 30 for receiving broadcasting including images such as still images and moving images.

Note that the original image in the explanation indicates an image that is a source for generating a viewpoint image corresponding to each virtual viewpoint, and the form of the original image is not especially limited as long as the viewpoint image can be generated. For example, the original image may be a still image or a moving image. Moreover, the original image may be a so-called stereo image for achieving stereoscopic vision or an image not considering stereoscopic vision (in other words, an image for one viewpoint). When an image not considering stereoscopic vision is acquired as an original image, the image processing device 10 may perform image analysis on the original image and generate each viewpoint image based on the analysis result. Also in the case of using a stereo image as an original image, when a viewpoint image considering larger viewpoints than the stereo image is necessary, the image processing device 10 may perform image analysis on the original image and generate a viewpoint image for the necessary viewpoints.

In addition, a source from which the image processing device 10 acquires an original image is not especially limited. For example, as illustrated in FIG. 1, the image processing device 10 may receive an original image distributed as broadcasting, through the antenna 30. As another example, the image processing device 10 may read out an original image recorded in an external medium from the external medium. As another example, the image processing device may include therein an storage unit for storing original images and read out an original image stored in the storage unit.

However, it is known that long-time viewing of 3D images causes eye strain, and the strain tends to appear remarkably particularly when viewing images with large parallaxes. Moreover, in the naked-eye 3D image technology, when the parallax is large, there may be occurred a phenomenon called crosstalk in which an image corresponding to one eye of right and left eyes may be leaked to the other eye and appears as a defocused image or a double image.

By contrast, the image processing device 10 of the embodiment is configured to adjust a parallax of a parallax image corresponding to each virtual viewpoint so that the stereoscopic effect is emphasized while maintaining a dynamic range of a parallax (hereinafter, also referred to as a “parallax range”) based on an original image. In such a configuration, the image processing device 10 of the embodiment can provide an image having the emphasized stereoscopic effect while suppressing occurrence of crosstalk.

In the following, the configuration of the display device 20 will be described first as a premise. Then, the detail of the image processing device 10 of the embodiment will be described while focusing on the processing of adjusting a parallax described above.

### [1.2. Configuration of Display Device]

First, an example of a configuration of the display device 20 according to the embodiment will be described with reference to FIG. 2. FIG. 2 is an explanatory diagram illustrating an example of a schematic configuration of the display device according to the embodiment. Note that in FIG. 2, an x-direction illustrated in a lateral direction indicates a horizontal direction relative to a display surface of the display device 20, while a y-direction illustrated in a vertical direction relative to the drawing indicates a vertical direction relative to the display surface of the display device 20. A z-direction illustrated in a longitudinal direction indicates a depth direction relative to the display surface of the display device 20.

As illustrated in FIG. 2, the display device 20 includes a backlight 21, a barrier 23, and a display panel 25. The configuration illustrated in FIG. 2 indicates a display device (a display) using a liquid crystal panel as the display panel 25, for example, and light cast from the backlight 21 and passing through the display panel 25 reaches a viewer as an image. In the configuration illustrated in FIG. 2, the barrier 23 is provided on the front side of the backlight 21. On the front side of the barrier 23, the display panel 25 is provided at a position separated with a given distance from the barrier 23.

The barrier 23 is composed of an optical material such as a lenticular plate or a parallax barrier. On the barrier 23, openings are provided with a given interval along the x-direction, and only light passing the openings of the barrier 23, among light casted from the backlight 21, reaches the display panel 25.

The display panel 25 includes a plurality of pixels. Each pixel of the display panel 25 is associated with control information (hereinafter, also referred to as an “index”) indicating any one of a plurality of predetermined virtual viewpoints, and is configured to display a pixel of a parallax image corresponding to the index. Note that the association between each pixel and each index is preliminarily designed in accordance with the positional relation among the barrier 23, the display panel 25, and each virtual viewpoint.

As a concrete example, in the example illustrated in FIG. 2, the display panel 25 includes pixels 25a to 25d respectively associated with indexes corresponding to different virtual viewpoints. For example, light La passing through an opening of the barrier 23 passes through the pixel 25a and converges to a virtual viewpoint M_{L} illustrated in FIG. 2, and light Lb passing through an opening of the barrier 23 passes through the pixel 25b and converges to a virtual viewpoint M_{R}. Here, when a left eye of a viewer is positioned at the virtual viewpoint M_{L} and a right eye of the viewer is positioned at the virtual viewpoint M_{R}, for example, a parallax image for left eye is displayed by the pixel 25a and a parallax image for right eye is displayed by the pixel 25b, whereby the viewer can view an image having the stereoscopic effect.

### [1.3. Configuration of Image Processing Device]

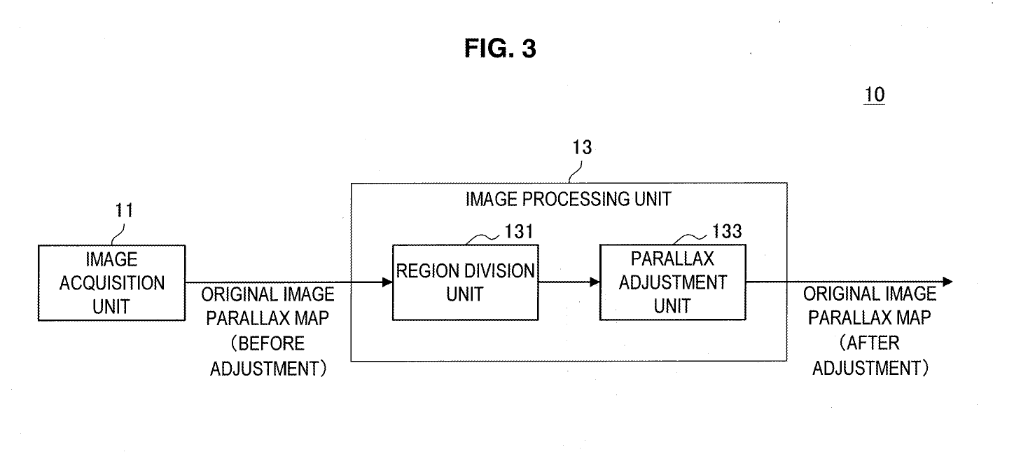

Next, the image processing device 10 of the embodiment will be described with reference to FIG. 3. FIG. 3 is a block diagram illustrating an example of a functional configuration of the image processing device 10 according to the embodiment. As illustrated in FIG. 3, the image processing device 10 includes an image acquisition unit 11 and an image processing unit 13. Moreover, the image processing unit 13 includes a region division unit 131 and a parallax adjustment unit 133.

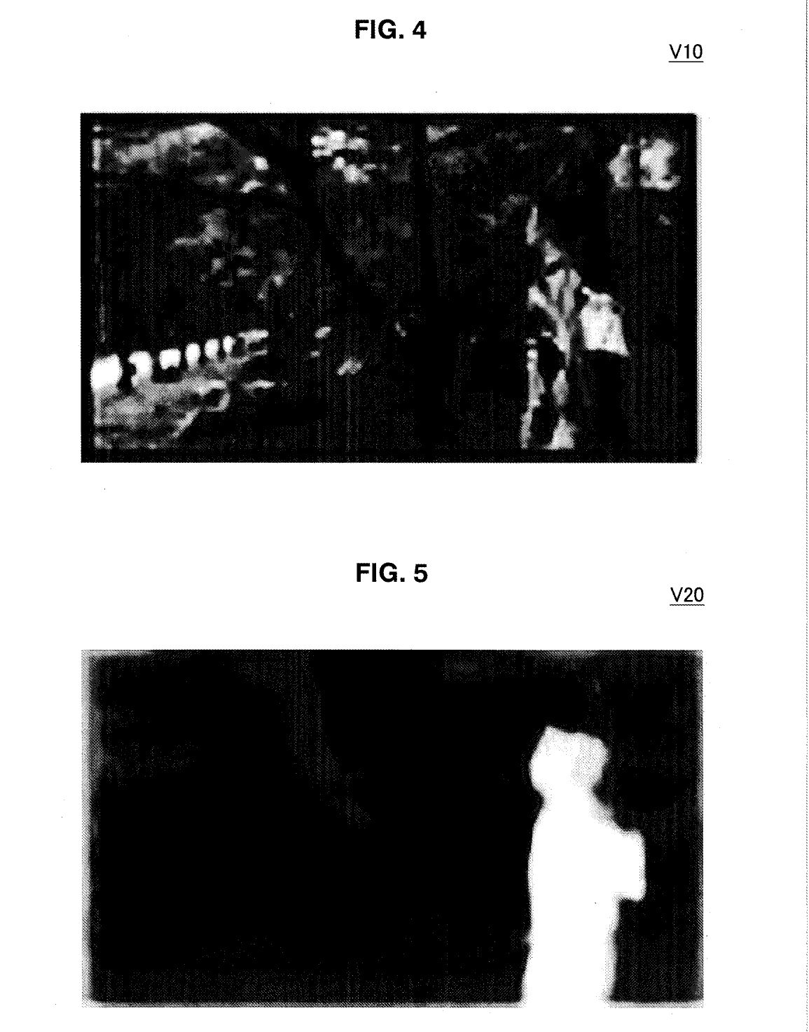

The image acquisition unit 11 externally acquires an original image that is a source for generating each viewpoint image to be displayed by the display device 20. As described above, the image acquisition unit 11 may receive an original image distributed as broadcasting, through the antenna 30, or read out an original image stored in an external medium from the external medium. For example, FIG. 4 illustrates an example of the original image. Hereinafter, when the original image illustrated in FIG. 4 is particularly referred to, it may be also indicated as an “original image V10”.

In addition, the image acquisition unit 11 acquires a parallax map indicating distribution of parallaxes between different viewpoint images (e.g., between an image for left eye and an image for right eye) that are set for pixels in an original image. Here, the image acquisition unit 11 may externally acquire a parallax map, similarly to an original image. As another example, the image acquisition unit 11 may analyze an acquired original image and generate a parallax map based on the analysis result. For example, FIG. 5 illustrates an example of the parallax map. A parallax map V20 illustrated in FIG. 5 is a parallax map corresponding to the original image V10 illustrated in FIG. 4. In the parallax map V20 illustrated in FIG. 5, a subject positioned on the more front side in a depth direction is displayed brighter (white), and a subject positioned on the more back side is displayed darker (black).

The image acquisition unit 11 outputs the acquired original image and parallax map to the region division unit 131.

The region division unit 131 acquires the original image and the parallax map from the image acquisition unit 11. The region division unit 131 divides the acquired original image to a plurality of regions based on subjects in the original image (that is, objects captured in the original image).

As a concrete example, the region division unit 131 may perform image processing on the original image, extract edges of objects in the original image, and divide the original image to regions based on the extracted edges.

As another example, the region division unit 131 may divide the original image to regions based on the parallax map. In such a case, the region division unit 131 may detect parts at which a parallax value is changed abruptly (that is, parts at which a change amount of a parallax exceeds a threshold) as borders, and divide the original image to regions in units of objects, based on the detected borders, for example. It is obvious that the region division unit 131 may divide the original image to regions using both the original image and the parallax map.

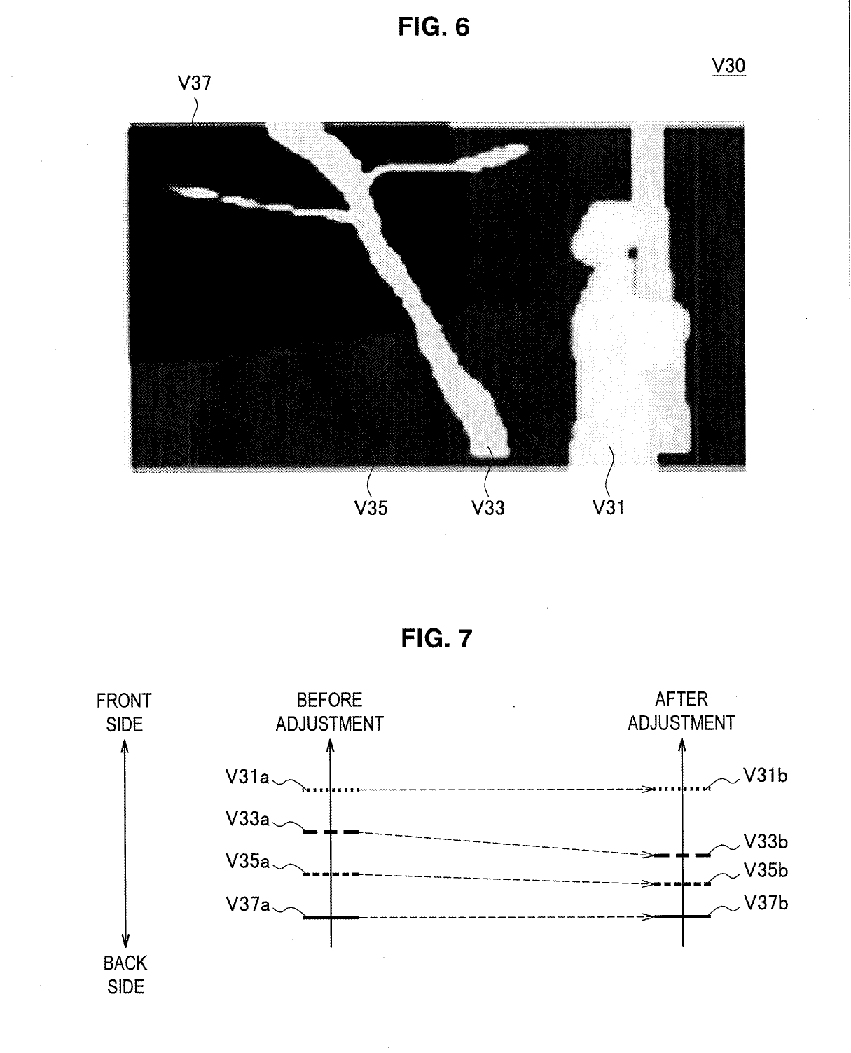

For example, FIG. 6 schematically illustrates regions divided based on the objects in the original image. In the example illustrated in FIG. 6, the original image V10 illustrated in FIG. 4 is divided to regions V31 to V37 based on the objects in the original image V10. Hereinafter, information indicating each of the regions V31 to V37 illustrated in FIG. 6 may be referred to as “region information V30”. Note that the form of the region information indicating each region in the original image is not especially limited as long as each region can be specified by the information. As a concrete example, the region information may be coordinate information indicating each region or vector information indicating each region. Moreover, the region information may be image information as illustrated schematically in FIG. 6.

The region division unit 131 outputs the acquired original image and parallax map and the region information indicating each region in the original image to the parallax adjustment unit 133.

The parallax adjustment unit 133 acquires the original image and the parallax map and the region information indicating each region in the original image from the region division unit 131.

The parallax adjustment unit 133 specifies, for each region indicated by the acquired region information, a parallax value set for each pixel included in the region, based on the acquired parallax map. Then, the parallax adjustment unit 133 calculates, for each region indicated by the region information, a representative parallax value corresponding to the region, based on parallax values of pixels included in the region, and associates the calculated representative parallax value with the region.

Note that the method of calculating a representative parallax value for each region is not especially limited as long as the representative parallax value is based on parallax values corresponding to pixels in the region. As a concrete example, the parallax adjustment unit 133 may calculate a median of parallax values corresponding to pixels included in a region as a representative parallax value of the region. As another example, the parallax adjustment unit 133 may calculate an average value of parallax values corresponding to pixels included in a region as a representative parallax value of the region. Hereinafter, the representative parallax value associated for each region may be simply referred to as a “parallax value corresponding to a region”.

In the manner described above, for each region indicated by the region information, the parallax value corresponding to the region is associated. FIG. 7 is an explanatory diagram for explaining processing of the parallax adjustment unit 133 for adjusting parallax values.

In FIG. 7, reference symbols V31a to V37a schematically illustrates positions in a depth direction of regions, which are indicated by parallax values respectively corresponding to the regions V31 to V37 illustrated in FIG. 6. That is, in the case of the example illustrated in FIG. 6, the region V31 is associated with a parallax value so that the region V31 is positioned on the most front side as compared with other regions. Then, the regions V33, V35, V37 are respectively associated with parallax values so that the regions V33, V35, V37 are positioned on the more front side in this order.

Next, the parallax adjustment unit 133 adjusts the parallax value corresponding to each region based on an attribute of the region indicated by the region information. Note that the attribute of the region is information (a parameter) indicating characteristics of the region and includes an area of the region and a position of the region (e.g., a position in a depth direction), for example.

As a concrete example, the parallax adjustment unit 133 adjusts the parallax value of each region, based on the position in a depth direction of the region, so that the region positioned on the more front side has a larger difference in parallax value from another region (e.g., an adjacent region in a depth direction or a region positioned in the vicinity in the original image).

For example, in the case illustrated in FIG. 7, the region V31 in FIG. 6 is positioned on the most front side as compared with the other regions V33 to V37, as illustrated by the reference symbols V31a to V37a. Thus, the parallax adjustment unit 133 adjusts the parallax value corresponding to the region V33 so that the difference in parallax value between the region V31 and the region V33 (the region adjacent to the region V31 in a depth direction) is larger, as illustrated by the reference symbols V31b to V37b.

Here, the parallax adjustment unit 133 may adjust the parallax value corresponding to the region V31 instead of the parallax value corresponding to the region V33. That is, the parallax adjustment unit 133 adjusts at least one of the parallax values of the region V31 and V33 relatively to the other parallax value as a reference, so that the difference in parallax value between the region V31 and the region V33 is larger.

Moreover, as another example, the parallax adjustment unit 133 may adjust the parallax value of each region so that a region having a smaller area has a larger difference in parallax from another region.

Moreover, the parallax adjustment unit 133 may adjust the parallax of each region based on not the attribute of a region but the attribute of an object (a subject) in the region. Note that the form in which the parallax value corresponding to each region is adjusted based on the attribute of an object in the region will be separately described later as a modification.

Moreover, the parallax adjustment unit 133 may adjust the parallax of each region based on not only one of attributes described above but the combination of a plurality of attributes. As a concrete example, the parallax adjustment unit 133 may adjust the parallax value of each region so that a region that has a smaller area and is positioned on the more front side has a larger difference in parallax from another region.

Here, it is more desirable that the parallax adjustment unit 133 adjusts the parallax value of each region so that the parallax range, that is, the maxim difference in parallax value between different regions is not changed before and after the adjustment of the parallax value, in terms of prevention of eye strain and suppression of cross talk (occurrence of defocusing or a double image).

However, such operation of the parallax adjustment unit 133 according to the embodiment is not limited to the form in which the parallax range is not changed in adjustment of the parallax value of each region. For example, the parallax adjustment unit 133 may change a parallax range, before and after the adjustment of the parallax value, in a range smaller than a change amount of a parallax value of each region (e.g., a maximum value, an average value, or a total of the change amount). Note that the description “maintain the parallax range” indicates both the case in which the parallax range is changed in a range smaller than a change amount of a parallax value of each region, as described above, and the case in which the parallax range is not changed.

Here, the following will describe in more detail the processing of the parallax adjustment unit 133 for adjusting the parallax value for each region.

First, it is supposed that the region division unit 131 divides an original image to N-pieces of regions, and a parallax value corresponding to i-th region (0≦i≦N−1) before adjustment is Dᵢ and a parallax value after adjustment is D′ᵢ. Note that for simplification of explication, 0.0=D₀≦D₁≦ . . . ≦D_{N-1}=1.0, 0.0=D′₀≦D′₁≦ . . . ≦D′_{N-1}=1.0 are supposed here. An energy function E is represented by the following (Expression 1), and an optimum parallax adjustment D′ₒₚ, is represented by the following (Expression 2), which results in an energy maximization problem.

$$\begin{matrix}E ( {D}_{0}^{′} , {D}_{1}^{′} , … , {D}_{N - 1}^{′} , ) = {\sum }_{( u , v ) ∈ P} \vert {D}_{u}^{′} - {D}_{v}^{′} \vert \times W ( {D}_{u}^{′} , {D}_{v}^{′} ) & ( 1 ) \\ {D}_{opt}^{′} = {argmax}_{{D}^{′} ∈ A } E ( {D}_{0}^{′} , {D}_{1}^{′} , … , {D}_{N - 1}^{′} , ) & ( 2 )\end{matrix}$$

Note that in the above (Expression 1), P indicates a set of pairs of regions adjacent to each other in a depth direction. Moreover, W (D′ᵤ, D′ᵥ) (>0) indicates a weight on a pair of the regions u, v.

For example, when W (D′ᵤ, D′ᵥ) is defined such that the average parallax of the regions u, v is larger on the more front side in a depth direction and is smaller on the more back side in a depth direction, the parallax between regions on the front side is emphasized, and the front-back relation between the regions is emphasized optimally as a whole.

Moreover, as another example, the parallax adjustment unit 133 may calculate conspicuity (otherwise, visual attraction, obviousness, or an attention level) of an object in each region and define W (D′ᵤ, D′ᵥ) such that the weight becomes larger as the calculated conspicuity is higher. In such a case, it is possible to emphasize (increase) the stereoscopic effect of parts focused on more easily by a viewer. Furthermore, with a component (e.g., a sensor or a camera) for detecting lines of sight of a user, the parallax adjustment unit 133 may specify a region focused on by a user based on the lines of sight of the user detected by such a component and define W (D′ᵤ, D′ᵥ) such that the weight on the specified region is larger.

Moreover, as described above, the parallax adjustment unit 133 may regard a region having a smaller area (that is, a smaller object in the region) as an object to be focused on more and define W (D′ᵤ, D′ᵥ) so that the weight on such a region is larger. It is needless to say that the above-mentioned methods of setting W (D′ᵤ, D′ᵥ) are merely examples and are not restrictive, and a plurality of setting standards may be combined.

In addition, it is also possible that a constraint condition for maintaining a parallax before adjustment is added to the above-described (Expression 1), which results in an energy maximization problem. The energy function E in such a case, that is, the energy function E considering a constraint condition for maintaining a parallax before adjustment is represented by the following (Expression 3).

$${\begin{matrix}E ( {D}_{0}^{′} , {D}_{1}^{′} , … , {D}_{N - 1}^{′} , ) = {\sum }_{( u , v ) ∈ P} \vert {D}_{u}^{′} - {D}_{v}^{′} \vert \times W ( {D}_{u}^{′} , {D}_{v}^{′} ) - λ {\sum }_{i = 0}^{N - 1} \vert ( {D}_{i}^{′} - {D}_{i} ) \vert & ( 3 )\end{matrix}}_{□}^{′′} \qquad ( 3 )$$

Note that in the above-described (Expression 3), λ is a non-negative constant, and the constraint for maintaining an original parallax value becomes stronger as the λ is larger.

After adjusting the parallax value corresponding to each region, the parallax adjustment unit 133 adjusts a parallax value of each pixel in the region based on the parallax value corresponding to the region after adjustment. For example, when a parallax value corresponding to a region before adjustment is D, a parallax value corresponding thereto after adjustment is D, a parallax value corresponding to each pixel in the region before adjustment is d, and a parallax value corresponding thereto after adjustment is d′, the parallax value d′ corresponding to each pixel after adjustment can be calculated based on the following (Expression 4).

d′=d+(D′−D)+α·(D−d) (4)

Note that in the above-described (Expression 4), the coefficient α is an actual value fulfilling the condition of 0≦α≦1. With coefficient α=0, a parallax value of a pixel in a region becomes equivalent to one in the case where a same amount of offset as a parallax value corresponding to the region is provided to the parallax value of the pixel in the region. Moreover, with coefficient α=1, a parallax value of a pixel in a region becomes equal to a parallax value corresponding to the region.

Note that the coefficient α may be set preliminarily as a given constant, or may be calculated dynamically. When the coefficient α is calculated dynamically, the parallax adjustment unit 133 may set the coefficient α so that after adjustment of the parallax value, a region having larger difference in parallax value from an adjacent region has a smaller value of the coefficient α. Moreover, as another example, the parallax adjustment unit 133 may adjust the coefficient α in accordance with a change amount before and after adjustment of the parallax value corresponding to the region.

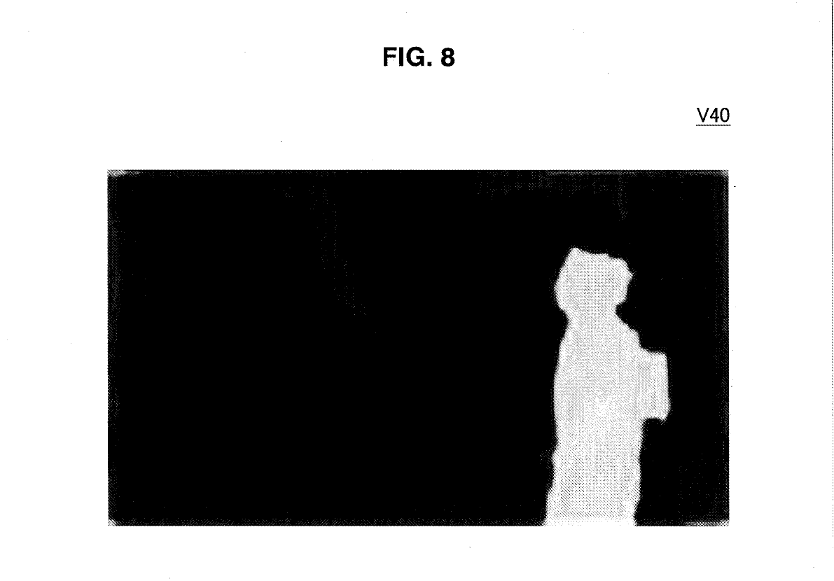

In the manner described above, the parallax adjustment unit 133 adjusts a parallax value for each region and thus corrects the parallax map. For example, FIG. 8 illustrates an example of the parallax map after adjustment. A parallax map V40 illustrated in FIG. 8 is a parallax map in which each parallax value in the parallax map V20 illustrated in FIG. 5 is adjusted and corrected for each region indicated by the region information V30 illustrated in FIG. 6. In the parallax map V40 illustrated in FIG. 8, each parallax value is adjusted so that the region (the object) positioned on the most front side is emphasized more, as is recognized by comparison with the parallax map V20 illustrated in FIG. 5.

After correcting the parallax map, the parallax adjustment unit 133 outputs the original image and the corrected (adjusted) parallax map to a component for generating viewpoint images (e.g., another image processing unit or the display device 20). Subsequently, a viewpoint image corresponding to each of predetermined virtual viewpoints is generated based on the original image and the corrected parallax map, and each of the generated viewpoint images is displayed on the display panel 25 of the display device 20.

In the example described above, the parallax value associated with each pixel in the original image is adjusted for each divided region. However, the object to be adjusted is not necessarily limited to the parallax value as long as the object is a parameter associated with each pixel. As a concrete example, in order to adjust the lightness, the contrast, the chroma, the shade, or the space frequency, for example, for each divided region, the image processing device 10 may be configured to adjust a parameter (e.g., a pixel value) associated with a pixel in the region.

### 2. PROCESSING FLOW

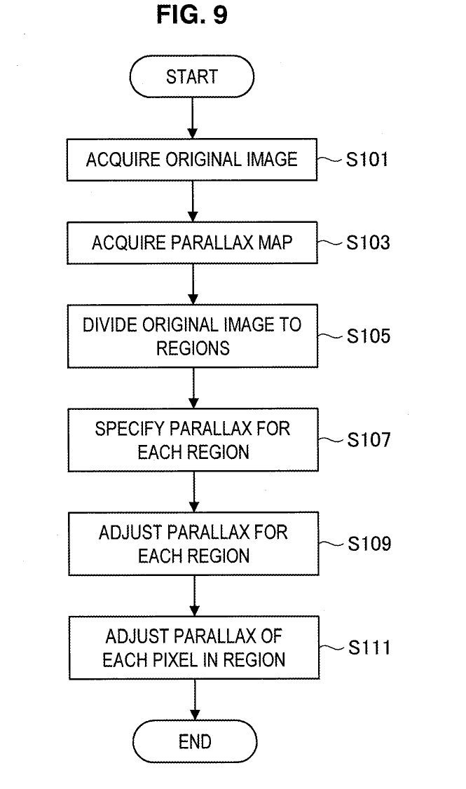

Next, a sequence flow of operation of the image processing device 10 according to the embodiment will be described with reference to FIG. 9. FIG. 9 is a flowchart illustrating a sequence flow of processing of the image processing device 10 according to the embodiment;

### (Step S101)

First, the image acquisition unit 11 externally acquires an original image that is a source for generating each viewpoint image to be displayed by the display device 20. Note that the image acquisition unit 11 may receive an original image distributed as broadcasting, through the antenna 30, or read out an original image stored in an external medium from the external medium.

### (Step S103)

Then, the image acquisition unit 11 acquires a parallax map indicating distribution of parallaxes between different viewpoint images (e.g., between an image for left eye and an image for right eye) that are set for pixels in the original image. Here, the image acquisition unit 11 may externally acquire the parallax map, similarly to the original image. As another example, the image acquisition unit 11 may analyze the acquired original image and generate the parallax map based on the analysis result.

The image acquisition unit 11 outputs the acquired original image and parallax map to the region division unit 131.

### (Step S105)

The region division unit 131 acquires the original image and the parallax map from the image acquisition unit 11. The region division unit 131 divides the acquired original image to a plurality of regions based on subjects in the original image (that is, objects captured in the original image).

The region division unit 131 outputs the acquired original image and parallax map and the region information indicating each region in the original image to the parallax adjustment unit 133.

### (Step S107)

The parallax adjustment unit 133 acquires the original image and the parallax map and the region information indicating each region in the original image from the region division unit 131.

The parallax adjustment unit 133 specifies, for each region indicated by the acquired region information, a parallax value set for each pixel included in the region, based on the acquired parallax map. Then, the parallax adjustment unit 133 calculates, for each region indicated by the region information, a representative parallax value corresponding to the region (that is, a parallax value corresponding to the region), based on the parallax values of pixels included in the region, and associates the calculated parallax value with the region.

### (Step S109)

Next, the parallax adjustment unit 133 adjusts the parallax value corresponding to each region based on an attribute of the region indicated by the region information. Note that the attribute of the region is information (a parameter) indicating characteristics of the region and includes an area of the region and a position of the region (e.g., a position in a depth direction), for example.

As a concrete example, the parallax adjustment unit 133 adjusts the parallax value of each region, based on the position in a depth direction of the region, so that the region positioned on the more front side has a larger difference in parallax value from another region (e.g., an adjacent region in a depth direction or a region positioned in the vicinity in the original image).

Moreover, as another example, the parallax adjustment unit 133 may adjust the parallax value of each region so that a region having a smaller area has a larger difference in parallax from another region.

Furthermore, the parallax adjustment unit 133 may adjust the parallax of each region based on not the attribute of a region but the attribute of an object (a subject) in the region.

Moreover, the parallax adjustment unit 133 may adjust the parallax of each region based on not only one of attributes described above but the combination of a plurality of attributes. As a concrete example, the parallax adjustment unit 133 may adjust the parallax value of each region so that a region that has a smaller area and is positioned on the more front side has a larger difference in parallax from another region.

Here, the parallax adjustment unit 133 adjusts the parallax value of each region so that the parallax range, that is, the maximum difference in parallax value between different regions is maintained before and after the adjustment of the parallax value.

### (Step S111)

After adjusting the parallax value corresponding to each region, the parallax adjustment unit 133 adjusts a parallax value of each pixel in the region based on the parallax value corresponding to the region after adjustment.

In the manner described above, the parallax adjustment unit 133 adjusts a parallax value for each region and thus corrects the parallax map.

After correcting the parallax map, the parallax adjustment unit 133 outputs the original image and the corrected (adjusted) parallax map to a component for generating viewpoint images (e.g., another image processing unit or the display device 20). Subsequently, a viewpoint image corresponding to each of predetermined virtual viewpoints is generated based on the original image and the corrected parallax map, and each of the generated viewpoint images is displayed on the display panel 25 of the display device 20.

As described above, the image processing device 10 according to the embodiment adjusts a parallax value of each region in accordance with an attribute of the region (e.g., an area or a position in a depth direction) so that the parallax range is maintained. Such a configuration allows further emphasis of a region fulfilling a given condition (e.g., a region having a small area or a region on the more front side), for example. In addition, the parallax range is maintained here before and after the adjustment, which can suppress occurrence of crosstalk and prevent eye strain.

### 3. MODIFICATION

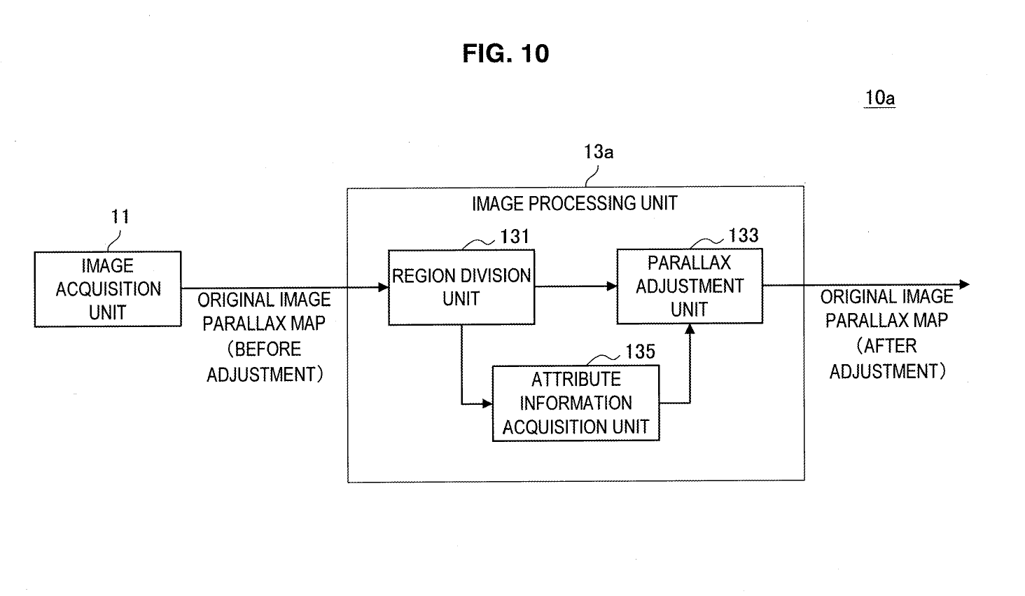

Next, an image processing device 10a according to a modification will be described. In the image processing device 10 according to the above-described embodiment, a parallax value corresponding to each region is adjusted based on mainly an attribute of each region indicated by region information (e.g., an area or a position in a depth direction of each region). However, the standard for adjusting the parallax value is not limited to the attribute of each region. For example, the image processing device 10a according to the modification adjusts a parallax value corresponding to each region based on an attribute of an object (a subject) in the region. Hereinafter, the detail of the image processing device 10a according to the modification will be described with reference to FIG. 10. FIG. 10 is a block diagram illustrating an example of a functional configuration of the image processing device 10a according to the modification.

As illustrated in FIG. 10, the image processing device 10a according to the modification includes the image acquisition unit 11 and an image processing unit 13a. Note that the configuration of the image acquisition unit 11 is same as in the image processing device 10 according to the embodiment described above, and thus the detailed explanation thereof is omitted.

The image processing unit 13a includes a region division unit 131, a parallax adjustment unit 133, and an attribute information acquisition unit 135. That is, the image processing unit 13a according to the modification is different from the image processing unit 13 in the image processing device 10 described above (see FIG. 3) in the attribute information acquisition unit 135 included therein.

The region division unit 131 acquires an original image and a parallax map from the image acquisition unit 11. The region division unit 131 divides the acquired original image to a plurality of regions based on subjects in the original image (that is, objects captured in the original image). Note that the operation of the region division unit 131 for dividing an original image to regions is same as in the image processing device 10 according to the embodiment described above.

The region division unit 131 outputs the acquired original image and parallax map and the region information indicating each region in the original image to the parallax adjustment unit 133. In addition, the region division unit 131 outputs the acquired original image and the region information indicating each region in the original image to the attribute information acquisition unit 135.

The attribute information acquisition unit 135 acquires the original image and the region information indicating each region in the original image from the region division unit 131.

The attribute information acquisition unit 135 extracts each region in the original image based on the acquired region information. Then, the attribute information acquisition unit 135 performs image analysis processing, for example, on each extracted region, and specifies an attribute of an object imaged in the region. Note that the attribute of an object includes a type of the object (that is, what (a person, etc.) is represented by the object), for example.

Moreover, it is needless to say that the attribute of an object is not limited to the type of the object as long as the object imaged in each region can be categorized based on a given standard. For example, the attribute information acquisition unit 135 may specify, as an attribute, the lightness, the contrast, the chroma, the shade, or the space frequency of an object imaged in each region. Moreover, the attribute information acquisition unit 135 may specify, as an attribute, the combination of some of information such as the lightness, the contrast, the chroma, the shade, or the space frequency of an object or the combination of all of them. As a concrete example, the attribute information acquisition unit 135 may quantitatively calculate a value related to the conspicuity such as visual attraction based on at least one part of the contrast, the chroma, the shade, and the space frequency of an object, and specify the calculated value related to the conspicuity as an attribute.

The attribute information acquisition unit 135 associates region information indicating each region with attribute information indicating an attribute of an object specified from the region. Then, the attribute information acquisition unit 135 outputs the attribute information associated with each region information to the parallax adjustment unit 133.

The parallax adjustment unit 133 acquires the original image and the parallax map and the region information indicating each region in the original image from the region division unit 131. Moreover, the parallax adjustment unit 133 acquires the attribute information associated with each region information from the attribute information acquisition unit 135.

The parallax adjustment unit 133 specifies, for each region indicated by the acquired region information, a parallax value set for each pixel included in the region, based on the acquired parallax map. Then, the parallax adjustment unit 133 calculates, for each region indicated by the region information, a representative parallax value corresponding to the region, based on the parallax values of pixels included in the region, and associates the calculated representative parallax value with the region. Note that the processing of the parallax adjustment unit 133 for associating, for each region indicated by the region information, a parallax value corresponding to the region is same as in the image processing device 10 according to the embodiment described above.

Next, the parallax adjustment unit 133 adjusts the parallax value corresponding to each region based on the attribute (information) associated with each region indicated by the region information. In the image processing device 10 (see FIG. 3) according to the embodiment described above, there has been explained the case in which the parallax adjustment unit 133 weights each region based on an attribute of the region (e.g., an area or a position in a depth direction of the region) and adjusts a parallax value corresponding to the region based on the weight. By contrast, the parallax adjustment unit 133 according to the modification may weight each region based on an attribute of an object in each region that is indicated by the attribute information acquired from the attribute information acquisition unit 135, and adjust a parallax value corresponding to the region based on the weight.

For example, the parallax adjustment unit 133 may specify the type of an object in each region based on the attribute information associated with the region, and weight the region in accordance with the specified type of the object. As a concrete example, the parallax adjustment unit 133 may weight each region so that the region in which the object type is a person is emphasized more (the difference in parallax between regions is larger).

It is needless to say that the parallax adjustment unit 133 may weight each region based on the combination of the attribute of each region described above and the attribute of an object in each region.

Note that the operation of the parallax adjustment unit 133 for adjusting a parallax value is same as in the image processing device 10 in the embodiment described above. That is, the parallax adjustment unit 133 adjusts the parallax value of each region so that the parallax range, that is, the maximum difference in parallax value between different regions is maintained before and after the adjustment of the parallax values.

In the manner described above, the parallax adjustment unit 133 adjusts a parallax value for each region and corrects the parallax map. After correcting the parallax map, the parallax adjustment unit 133 outputs the original image and the corrected (adjusted) parallax map to a component for generating viewpoint images (e.g., another image processing unit or the display device 20). Subsequently, a viewpoint image corresponding to each of predetermined virtual viewpoints is generated based on the original image and the corrected parallax map, and each of the generated viewpoint images is displayed on the display panel 25 of the display device 20.

As described above, the image processing unit 10a according to the modification adjusts a parallax value of each region in accordance with an attribute of an object in the region so that the parallax range is maintained. Such a configuration allows further emphasis of a region in which a given object (e.g., a person) is imaged, for example. In addition, the parallax range is maintained here before and after the adjustment, which can suppress occurrence of crosstalk and prevent eye strain.

In the example described above, there is explained the case in which each region is weighted based on a predetermined standard. However, the standard for weighting may be switched dynamically. For example, the image processing device 10a may perform image analysis on an original image to specify a scene in which the original image is captured, and change the standard for weighting on each region in accordance with the specified scene. As a concrete example, when the specified scene is a portrait, the image processing device 10a may adjust a parallax value of each region so that a region in which the object type is a person is emphasized more. Moreover, when the specified scene is a view, the image processing device 10a may adjust a parallax value of each region so that a close-range view (the front side in a depth direction) is emphasized more.

### 4. HARDWARE CONFIGURATION

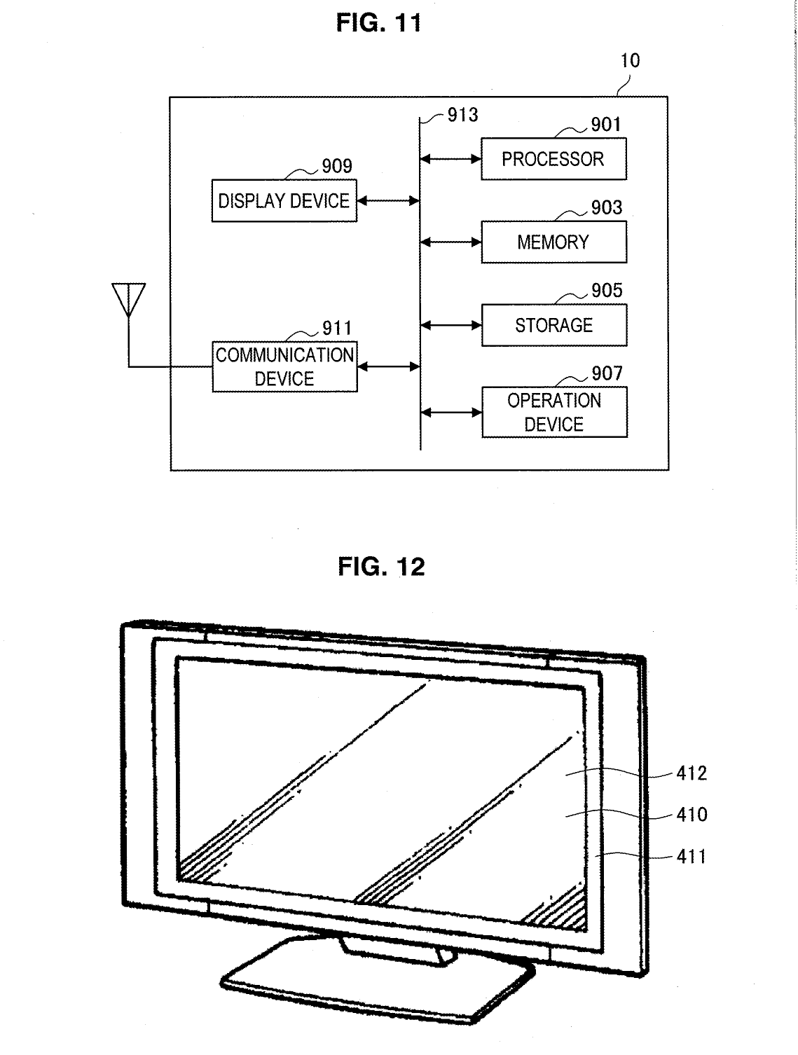

Next, an example of a hardware configuration of the image processing device 10 according to the embodiment will be described with reference to FIG. 11. FIG. 11 is a diagram illustrating an example of a hardware configuration of the image processing device 10 according to the embodiment.

As illustrated in FIG. 11, the image processing device 10 according to the embodiment includes a processor 901, a memory 903, a storage 905, an operation device 907, a display device 909, a communication device 911, and a bus 913.

The processor 901 may be a central processing unit (CPU), a graphics processing unit (GPU), a digital signal processor (DSP), or a system on chip (SoC), for example, and executes various kinds of processing of the image processing unit 10. The processor 901 can be configured by an electronic circuit for executing various kinds of arithmetic processing, for example. Note that the image acquisition unit 11 and the image processing unit 13, which are described above, can be configured by the processor 901.

The memory 903 includes a random access memory (RAM) and a read only memory (ROM), and stores programs and data executed by the processor 901. The storage 905 may include a storage medium such as a semiconductor memory or a hard disk.

The operation device 907 has a function of generating input signals for desired operation by a user. The operation device 907 may include an input unit for input of information by a user, such as a button and a switch, for example, and an input control circuit for generating input signals based on an input of a user and supplying the input signals to the processor 901.

The display device 909 is an example of an output device, and may be a display device such as a liquid crystal display (LCD) device and an organic light emitting diode (OLED) display device. The display device 909 can provide information by displaying a screen to a user. Note that the above-described display device 20 may be configured as the display device 909, or the display device 909 may be provided separately from the display device 20.

The communication device 911 is a communication device included in the image processing device 10, and performs communication with an external device through a network. The communication device 911 is an interface for wireless communication, and may include a communication antenna, a radio frequency (RF) circuit, and a base band processor, for example.

The communication device 911 has a function of performing various kinds of signal processing on signals received from an external device, and can provide digital signals generated based on received analog signals to the processor 901.

The bus 913 mutually connects the processor 901, the memory 903, the storage 905, the operation device 907, the display device 909, and the communication device 911. The bus 913 may include a plurality of kinds of buses.

Moreover, it is possible to generate a program for causing hardware such as a CPU, a ROM, and a RAM included in a computer to exert the same functions as the components of the image processing device 10 described above. In addition, it is also possible to provide a computer-readable storage medium having the program therein.

### 5. APPLICATION EXAMPLES

The following will describe application examples of the above-described image processing device according to the embodiment with the use of concrete examples.

### 5.1. Application Example 1

### Television Device

FIG. 12 illustrates an appearance configuration of a television device. The television device is provided with an image display screen 410 (the display device 20) including a front panel 411 and a filter glass 412, for example. Note that a device (e.g., a processor such as a CPU or a GPU) related to display of an image on the image display screen 410, which is provided in a housing of the television device, corresponds to the image processing device 10 according to the embodiment described above. When the above-described embodiment is applied to the television device, the parallax of a given object can be expressed more effectively, and the crosstalk can be also prevented. Therefore, it is possible to reduce viewer's feeling of fatigue even in the television device supposing long-time viewing, which contributes to the improvement of marketability.

### 5.2. Application Example 2

### Smartphone

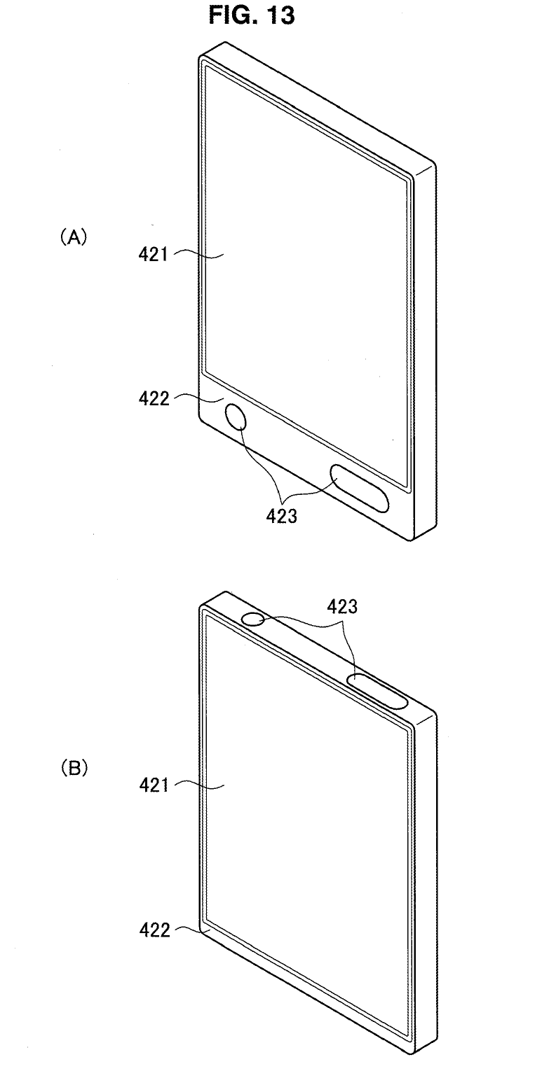

FIG. 13 illustrates an external appearance of a smartphone. The smartphone includes a display unit 421 (the display device 20), a non-display part (a housing) 422, and an operation unit 423, for example. The operation unit 423 may be provided on the front surface of the non-display part 422, as illustrated in (A), or may be provided on the upper surface, as illustrated in (B). Note that a device (e.g., a processor such as a CPU or a GPU) related to display of an image on the display unit 421, which is provided in the non-display part (the housing) 422, corresponds to the image processing device 10 according to the embodiment described above. When the above-described embodiment is applied to the smartphone, the stereoscopic effect can be emphasized even in a smartphone having a smaller expressible parallax than a large-sized display device such as a television device, which contributes to the improvement of marketability.

It is needless to say that the application examples described above are merely one examples and do not limit the configuration to which the image processing device according to the embodiment can be applied.

### 6. CONCLUSION

As described above, the image processing device 10 according to the embodiment adjusts a parallax value of each region, in accordance with information related to the region such as an attribute of the region (e.g., an area or a position in a depth direction) or an attribute of an object in the region, so that the parallax range is maintained. Such a configuration allows further emphasis of a region fulfilling a given condition, for example. In addition, the parallax range is maintained before and after the adjustment, which can suppress occurrence of crosstalk and prevent eye strain. That is, the image processing device 10 according to the embodiment can emphasize the stereoscopic effect in the state where the magnitude of a parallax is restricted.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

Moreover, the effects described in the present specification are merely explanatory or representative, and are not restrictive. That is, the technology according to the present disclosure can exert, together with the above-described effects or instead of the above-described effects, another effect that is obvious for a person skilled in the art based on the description of the present specification. Additionally, the present technology may also be configured as below.

(1) An image processing method including:

acquiring an original image and a parallax map indicating distribution of parallaxes in the original image;

dividing the acquired original image into a plurality of regions based on objects in the original image; and

adjusting at least a parallax of one region relative to another region different from the one region, among the regions, based on information associated with the one region or the another region, in a range where a dynamic range of the parallax in the parallax map is maintained.

(2) The image processing method according to (1),

wherein the information associated with the one region or the another region is the parallax, and

wherein the parallax of the one region is relatively adjusted with reference to the parallax of the another region.

(3) The image processing method according to (2),

wherein the parallax of the one region is adjusted in a manner that a difference in parallax between the one region and the another region is large.

(4) The image processing method according to any one of (1) to (3),

wherein the parallax associated with the one region is adjusted based on an attribute of an object displayed in one of the one region and the another region.

(5) The image processing method according to (4),

wherein the attribute of the object indicates a type of the object, and

wherein the parallax of the one region is adjusted in a manner that a difference in parallax is large between the region in which the object type indicates a person and another region different from the region.

(6) The image processing method according to (4),

wherein the attribute of the object indicates an attention level of the object, and

wherein the parallax of the one region is adjusted in a manner that a region having the higher attention level of the object has a larger difference in parallax from another region different from the region.

(7) The image processing method according to any one of (1) to (3),

wherein the parallax associated with the one region is adjusted in accordance with a scene in which the original image is captured.

(8) The image processing method according to any one of (1) to (3),

wherein the parallax associated with the one region is adjusted based on an area of one of the one region and the another region.

(9) The image processing method according to (8),

wherein the parallax of the one region is adjusted in a manner that a region having the smaller area has a larger difference in parallax from another region different from the region.

(10) The image processing method according to any one of (1) to (3),

wherein the parallax associated with the one region is adjusted based on a position in a depth direction of one of the one region and the another region.

(11) The image processing method according to (10),

wherein the parallax of the one region is adjusted in a manner that a region positioned on a more front side in the depth direction has a larger difference in parallax from another region different from the region.

(12) The image processing method according to any one of (1) to (11),

wherein the original image is divided to the regions for each object based on the distribution of parallaxes indicated in the parallax map.

(13) The image processing method according to any one of (1) to (12),

wherein the one region and the another region are adjacent to each other along a depth direction.

(14) The image processing method according to any one of (1) to (13),

wherein a parallax associated with the one region is determined based on parallaxes associated with respective pixels in the one region in the original image.

(15) The image processing method according to (14),

wherein the parallax associated with the one region is determined based on a median of the parallaxes associated with the respective pixels in the one region in the original image.

(16) The image processing method according to any one of (1) to (15),

wherein a parallax associated with each pixel in the one region after a parallax associated with the one region is adjusted, is adjusted based on the parallax associated with the one region.

(17) An image processing device including:

an acquisition unit configured to acquire an original image and a parallax map indicating distribution of parallaxes in the original image;

a region division unit configured to divide the acquired original image into a plurality of regions based on objects in the original image; and

a parallax adjustment unit configured to adjust at least a parallax of one region relative to another region different from the one region, among the regions, based on information associated with the one region or the another region, in a range where a dynamic range of the parallax in the parallax map is maintained.

(18) An electronic device including:

an acquisition unit configured to acquire an original image and a parallax map indicating distribution of parallaxes in the original image;

a region division unit configured to divide the acquired original image into a plurality of regions based on objects in the original image; and

a parallax adjustment unit configured to adjust at least a parallax of one region relative to another region different from the one region, among the regions, based on information associated with the one region or the another region, in a range where a dynamic range of the parallax in the parallax map is maintained.

What is claimed is:

1. An image processing method comprising:
acquiring an original image and a parallax map indicating distribution of parallaxes in the original image;
dividing the acquired original image into a plurality of regions based on objects in the original image; and
adjusting at least a parallax of one region relative to another region different from the one region, among the regions, based on information associated with the one region or the another region, in a range where a dynamic range of the parallax in the parallax map is maintained.

2. The image processing method according to claim 1,
wherein the information associated with the one region or the another region is the parallax, and
wherein the parallax of the one region is relatively adjusted with reference to the parallax of the another region.

3. The image processing method according to claim 2,
wherein the parallax of the one region is adjusted in a manner that a difference in parallax between the one region and the another region is large.

4. The image processing method according to claim 1,
wherein the parallax associated with the one region is adjusted based on an attribute of an object displayed in one of the one region and the another region.

5. The image processing method according to claim 4,
wherein the attribute of the object indicates a type of the object, and
wherein the parallax of the one region is adjusted in a manner that a difference in parallax is large between the region in which the object type indicates a person and another region different from the region.

6. The image processing method according to claim 4,
wherein the attribute of the object indicates an attention level of the object, and
wherein the parallax of the one region is adjusted in a manner that a region having the higher attention level of the object has a larger difference in parallax from another region different from the region.

7. The image processing method according to claim 1,
wherein the parallax associated with the one region is adjusted in accordance with a scene in which the original image is captured.

8. The image processing method according to claim 1,
wherein the parallax associated with the one region is adjusted based on an area of one of the one region and the another region.

9. The image processing method according to claim 8,
wherein the parallax of the one region is adjusted in a manner that a region having the smaller area has a larger difference in parallax from another region different from the region.

10. The image processing method according to claim 1,
wherein the parallax associated with the one region is adjusted based on a position in a depth direction of one of the one region and the another region.

11. The image processing method according to claim 10,
wherein the parallax of the one region is adjusted in a manner that a region positioned on a more front side in the depth direction has a larger difference in parallax from another region different from the region.

12. The image processing method according to claim 1,
wherein the original image is divided to the regions for each object based on the distribution of parallaxes indicated in the parallax map.

13. The image processing method according to claim 1,
wherein the one region and the another region are adjacent to each other along a depth direction.

14. The image processing method according to claim 1,
wherein a parallax associated with the one region is determined based on parallaxes associated with respective pixels in the one region in the original image.

15. The image processing method according to claim 14,
wherein the parallax associated with the one region is determined based on a median of the parallaxes associated with the respective pixels in the one region in the original image.

16. The image processing method according to claim 1,
wherein a parallax associated with each pixel in the one region after a parallax associated with the one region is adjusted, is adjusted based on the parallax associated with the one region.

17. An image processing device comprising:
an acquisition unit configured to acquire an original image and a parallax map indicating distribution of parallaxes in the original image;
a region division unit configured to divide the acquired original image into a plurality of regions based on objects in the original image; and
a parallax adjustment unit configured to adjust at least a parallax of one region relative to another region different from the one region, among the regions, based on information associated with the one region or the another region, in a range where a dynamic range of the parallax in the parallax map is maintained.

18. An electronic device comprising:
an acquisition unit configured to acquire an original image and a parallax map indicating distribution of parallaxes in the original image;
a region division unit configured to divide the acquired original image into a plurality of regions based on objects in the original image; and
a parallax adjustment unit configured to adjust at least a parallax of one region relative to another region different from the one region, among the regions, based on information associated with the one region or the another region, in a range where a dynamic range of the parallax in the parallax map is maintained.
